(19) United States
(12) Patent Application Publication
(10) Pub. No.: US 2024/0111206 A1
(43) Pub. Date: Apr. 4, 2024

(54) ELECTRONIC APPARATUS

(71) Applicant: CASIO COMPUTER CO., LTD., Tokyo (JP)

(72) Inventors: Hirofumi FUJIKURA, Tokyo (JP); Yuta FUKAMI, Tokyo (JP)

(73) Assignee: CASIO COMPUTER CO., LTD., Tokyo (JP)

(21) Appl. No.: 18/373,426

(22) Filed: Sep. 27, 2023

(30) Foreign Application Priority Data
Oct. 4, 2022 (JP) 2022-160000

(51) Int. Cl. G03B 21/14; G03B 21/16

(52) U.S. Cl. CPC G03B 21/145; G03B 21/16

(57) ABSTRACT

An electronic apparatus includes a first case, a second case provided in such a manner that an internal part is disposed between the first case and the second case, and a cover configured to cover an opposite side of the second case to a side facing the internal part, and a heat conductivity of the second case is higher than a heat conductivity of the cover.

### CROSS-REFERENCE TO RELATED APPLICATION

This patent application is based upon and claims the benefit of priority under 35 USC 119 of Japanese Patent Application No. 2022-160000 filed on Oct. 4, 2022, the entire disclosure of which, including the specification, claims, drawings, and abstract, is incorporated herein by reference in its entirety.

### BACKGROUND

### Technical Field

The present disclosure relates to an electronic apparatus.

### Description of the Related Art

There have conventionally been known electronic apparatuses in which an internal part is disposed between an upper case and a lower case. For example, Japanese Unexamined Patent Application Publication No. 2018-17964 (JP-A-2018-17964) discloses a projector (an electronic apparatus) which includes an external case having an upper case and a lower case and in which the upper case and the lower case are assembled together in such a manner that a device main body corresponding to an internal structure of the projector is held vertically therebetween.

### SUMMARY

According to an aspect of the present disclosure, there is provided an electronic apparatus including a first case, a second case provided in such a manner that an internal part is disposed between the first case and the second case, and a cover configured to cover an opposite side of the second case to a side facing the internal part, wherein a heat conductivity of the second case is higher than a heat conductivity of the cover.

### BRIEF DESCRIPTION OF THE DRAWINGS

FIG. 1 is a perspective view of a projector according to an embodiment of the present disclosure as viewed from a front upper side;

FIG. 2 is an exploded perspective view of the projector according to the embodiment;

FIG. 3 is an exploded perspective view of an upper case, a lower case, and a bottom cover which make up a case of the projector according to the embodiment;

FIG. 4 is a perspective view of the projector according to the embodiment with the upper case removed as viewed from the front upper side;

FIG. 5 is a perspective view of the lower case of the projector according to the embodiment as viewed from the front upper side;

FIG. 6A is a perspective view of a convex portion on the lower case of the projector according to the embodiment as viewed from a lower side;

FIG. 6B is a perspective view of a modified example of a convex portion on the lower case of the projector according to the embodiment as viewed from the lower side;

FIG. 7 is a perspective view of the bottom cover of the projector according to the embodiment as viewed from the front upper side;

FIG. 8 is a perspective view of the lower case, the bottom cover, a lens barrel, and an IC circuit board of the projector according to the embodiment as viewed from the front upper side; and

FIG. 9 is a sectional view taken along a line IX-IX in FIG. 8, showing sections of the lower case, the bottom case, and the IC circuit board of the projector according to the embodiment.

### DESCRIPTION OF THE EMBODIMENT

Hereinafter, an embodiment of the present disclosure will be described by reference to drawings.

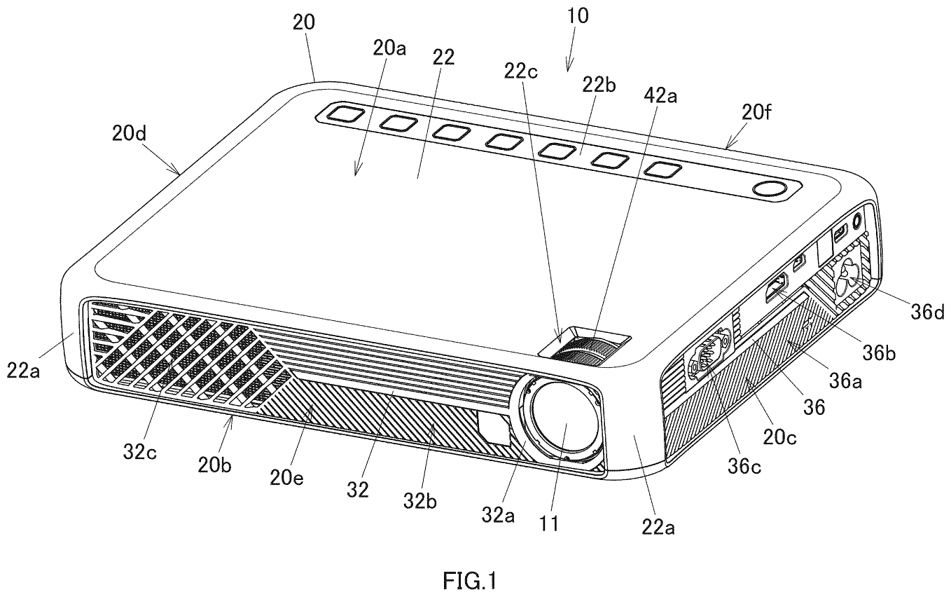

As shown in FIG. 1, a projector (an electronic apparatus) 10 according to an embodiment of the present disclosure includes a case 20 of a substantially elongated rectangular parallelepiped box shape whose longitudinal direction follows a left-right direction and which has six sides or surfaces (an upper surface 20a, a lower surface 20b, a left surface 20c, a right surface 20d, a front surface, 20e, and a rear surface 20f).

The projector 10 has a projection port 11 from which projected light is emitted in the front surface 20e.

In the following description, when “left and right” are referred to in relation to the projector 10, they denote a left-right direction with respect to a direction in which projected light is emitted from the projection port 11.

In addition, when “front and rear” are referred to in relation to the projector 10, they denote a front-rear direction with respect to a traveling direction of projected light emitted from the projector 10. Additionally, in the following description, a side of the projector 10 where the upper surface 20a lies constitutes an upper side of the projector 10, and a side of the projector 10 where the lower surface 20b lies constitutes a lower side of the projector 10.

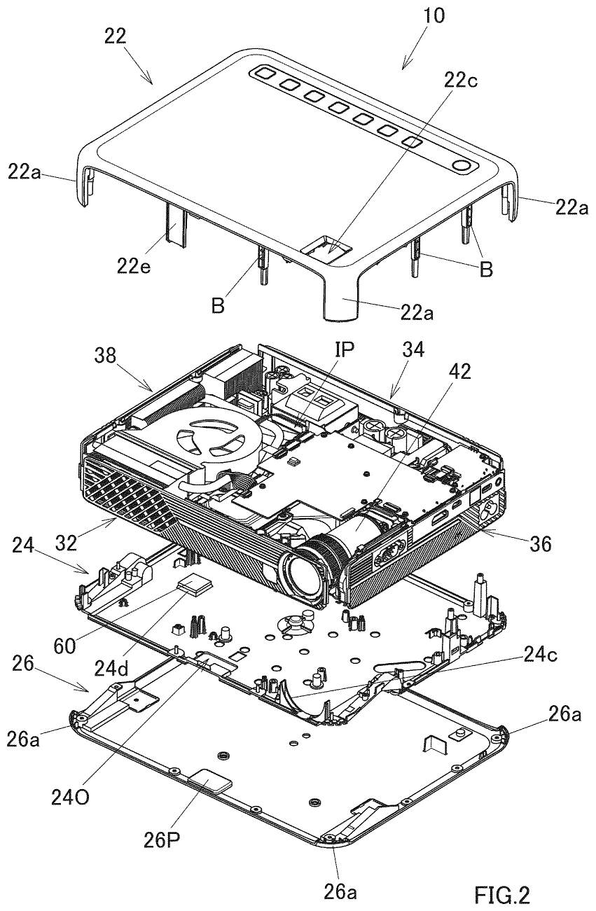

As shown in FIG. 2, the case 20 has an upper case (a first case) 22 including the upper surface 20a and four corner portions, a lower case (a second case) 24, and a bottom cover (a cover member) 26 including the lower surface 20b.

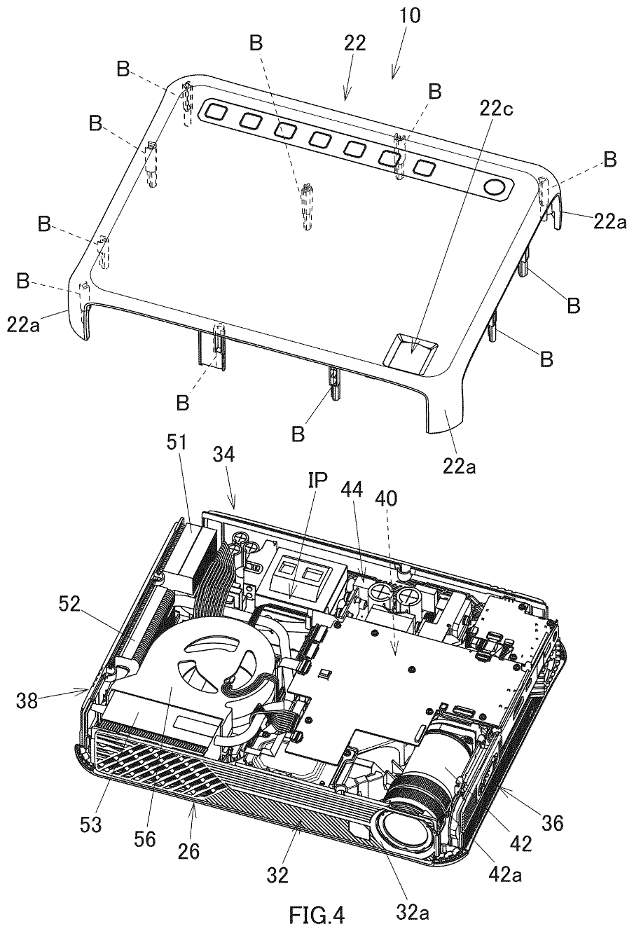

Internal parts IP (refer to FIG. 4) making up the projector 10 are disposed between the upper case 22 and the lower case 24 in an interior portion of the case 20.

The upper case 22, the internal parts IP, and the lower case 24 are aligned in an up-down direction (an aligning direction).

In addition, the case 20 has a front panel (a side panel) 32 including the front surface 20e on a front side, a rear panel (a side panel) 34 including the rear surface 20f on a rear side, a left panel (a side panel) 36 including the left surface 20c on a left side, and a right panel (a side panel) 38 including the right surface 20d on a right side.

The upper case 22 has case corner portions 22a which make up the four corner portions of the case 20. Each case corner portion 22a extends downwards and comes into abutment with the bottom cover 26 at a distal end portion (a lower end portion) thereof.

An operation panel 22b is provided on the upper surface 20a of the upper case 22, and this operation panel 22b includes a group of buttons with which the projector 10 can be set in predetermined modes. In addition, a substantially rectangular adjustment opening portion 22c is provided in a left front corner portion of the upper surface 20a of the upper case 22.

A movable adjustment ring 42a, which is provided on a lens barrel 42 (refer to FIG. 4) accommodated in the case 20, is exposed from an opening in the adjustment opening portion 22c. The projection port 11, from which projected light is emitted, is provided at a front end portion of the lens barrel 42.

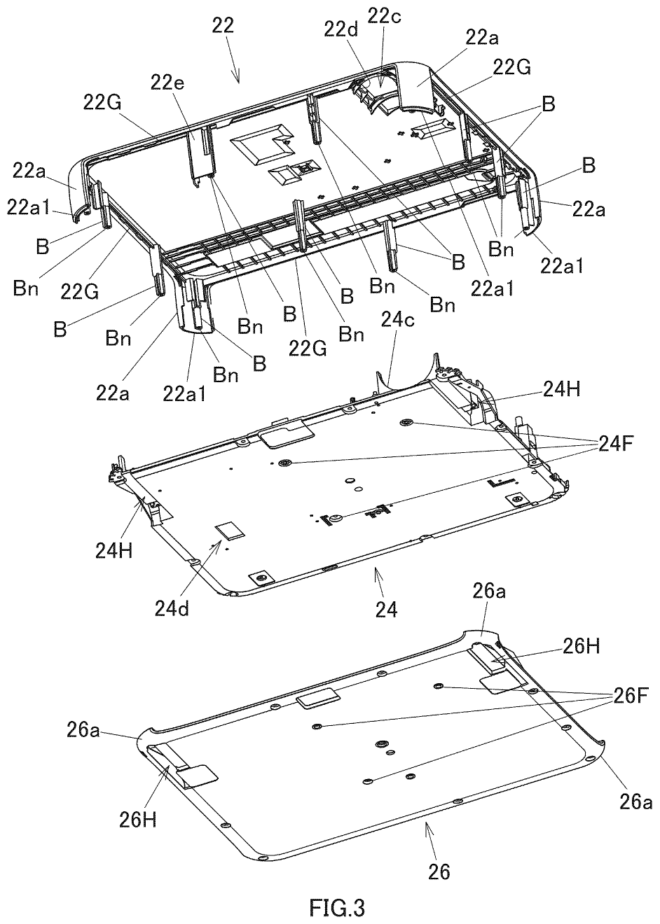

The bottom cover 26 covers substantially a whole area of the lower case 24 from an external side (an opposite side to a side which faces the internal parts IP). A cover-side hinge attachment portion 26H is provided on each of left and right sides of a front portion of the bottom cover 26 for attachment of a tilt hinge mechanism of the projector 10 (refer to FIG. 3).

The individual panels 32, 34, 36, 38, which make up the side surfaces of the case 20, are each a rectangular panel member, and as will be described later, upper end edges (one end edges in a transverse direction) thereof are brought into engagement with the upper case 22, whereas lower end edges (the other end edges in the transverse direction) thereof are brought into engagement with the lower case 24.

In addition, both end portions of each of the panels 32, 34, 36, 38 in a longitudinal direction are brought into abutment with internal sides of the corresponding case corner portions 22a. A projection port opening portion 32a, from which the projection port 11 of the lens barrel 42 is exposed, a first outside air inlet port 32b, and an inside air outlet port 32c are provided in the front panel 32.

A second outside air inlet port 32b, an image input connector connection port 36b, an external control serial connector connection port 36c, a power supply plug connection port 36d, and the like are provided in the left panel 36.

A third outside air inlet port and a fourth outside air inlet port, which are not shown, are provided in the right panel 38.

Here, referring to FIG. 4, the internal parts IP will be described which are accommodated in the case 20 of the projector 10.

As shown in FIG. 4, the internal parts IP of the projector 10 include a light source apparatus 40, which is disposed slightly leftwards of a substantially central portion of the case 20 and is covered with a protection cover, and the lens barrel 42, which is disposed in the vicinity of the left front corner portion of the case 20.

As the internal parts IP, a control circuit board 44, on which a control unit or the like of the projector 10 is mounted, is disposed at a rear portion of the case 20.

In addition, as the internal parts IP, the projector 10 includes a first cooling device 51, which is disposed on a right side of the control circuit board 44, and a second cooling device 52 and a third cooling device 53, which are disposed forwards on a right side of the case 20.

Heat pipes or the like are disposed between the light source apparatus 40 and the individual cooling devices 51, 52, 53.

In addition, the projector 10 includes a cooling fan 56 in a portion (a right portion of the case 20) which is surrounded by the light source apparatus 40, the control circuit board 44, the second cooling device 52, and the third cooling device 53.

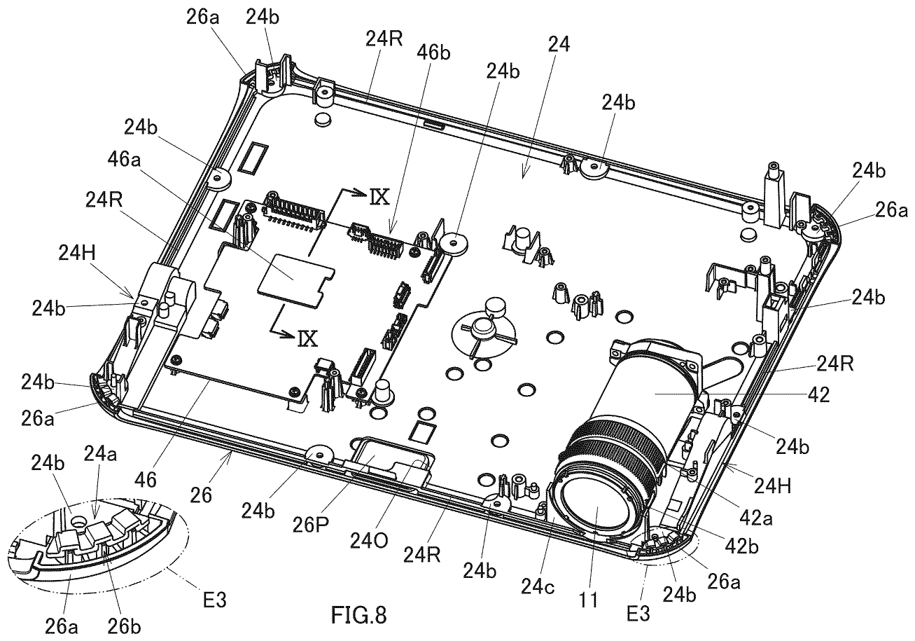

As shown in FIG. 8, an IC circuit board 46 is provided on a lower side (between the cooling fan 56 and the lower case 24) of the cooling fan 56.

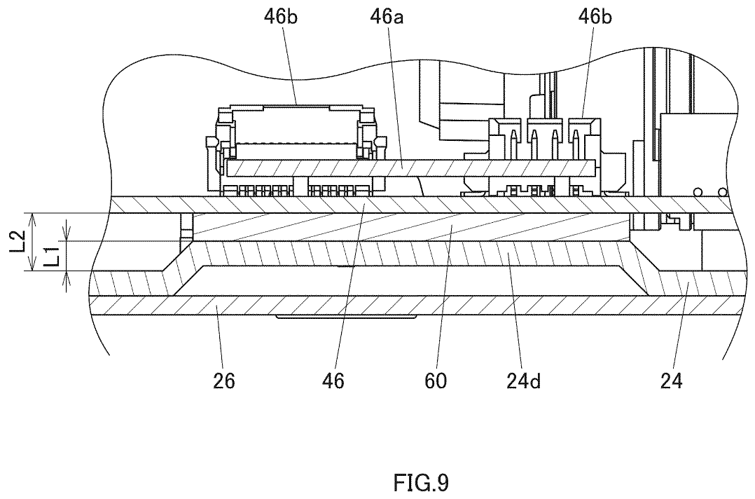

The IC circuit board 46 is provided in such a manner as to be slightly spaced away from a plate surface of the lower case 24 (refer to FIG. 9), and an IC 46a, which constitutes a heat generating member, is provided substantially at a central portion on the plate surface of the lower case 24.

A contact terminal group 46b, which is configured to be connected to the light source apparatus 40, the control circuit board 44, and the like, is provided at an end edge portion on a plate surface of the IC circuit board 46.

Subsequently, the configuration of each of the members which make up the case 20 will be described in detail.

Firstly, referring to FIGS. 3 and 4, the upper case 22 will be described.

The upper case 22 is made up of a substantially rectangular flat plate member having four rounded corners. The material of the upper case 22 is, for example, a mixed resin of acrylonitrile-butadiene-styrene (ABS) and polycarbonate (PC), and the heat conductivity of the mixed resin is in the range of 0.19 to 0.33 (W/m·K).

Each case corner portion 22a of the upper case 22 has a corner portion stopper 22a1 at a distal end portion thereof, and this corner portion stopper 22a1 is made thinner in thickness and protrudes slightly downwards.

Each corner portion stopper 22a1 is brought into abutment with an internal surface of a corner portion receiver 26a of the bottom cover 26, which will be described later, on an external surface thereof.

On an internal surface side (a lower surface side) of the upper case 22, an upper support 22d is provided around the opening in the adjustment opening portion 22c to support an upper side of an end portion of the lens barrel 42 where the projection port 11 is provided.

The upper support 22d protrudes downwards substantially into an arc shape which is defined along an outer circumferential surface of the lens barrel 42 with a concave surface of the arc shape directed downwards.

On the internal surface side (the lower surface side) of the upper case 22, multiple bosses B are provided in such a manner as to extend in the up-down direction. Most of the multiple bosses B are provided on end edge portions of a lower surface of the upper case 22, while one boss B is provided in a position lying slightly rearwards and rightwards of a central portion of the lower surface of the upper case 22.

A distal end portion of each boss B is formed substantially into a cylindrical shape, and a threaded hole Bn is provided inside the cylindrical distal end portion of the boss B. Additionally, an upper case groove 22G is provided along external edge portions of the internal surface side of the upper case 22 in such a manner as to form a groove along the external edge portions.

A partition plate 22e is provided in a position lying slightly rightwards on a front edge portion of the outer edge portions of the internal surface side of the upper case 22 to separate the first outside air inlet port 32b from the inside air outlet port 32c of the projector 10.

Subsequently, referring to FIGS. 2 and 4, the panels 32, 34, 36, 38 which make up the side surfaces of the case 20 will be described.

The panels 32, 34, 36, 38 are made up of a laterally elongated mesh-like flat plate member.

Upper end portions of the panels 32, 34, 36, 38 are each formed into a rib, which is configured to be brought into engagement with the upper case groove 22G which is provided along circumferential edge sides of the upper case 22.

On the other hand, lower end portions of the panels 32, 34, 36, 38 are each formed into a groove, which is configured to be brought into engagement with a lower case rib 24R which is provided along circumferential edge sides of the lower case 24. The lower case rib 24R and the lower case 24 will be described later. The panels 32, 34, 36, 38 are fixed in such a state that the panels are held to be fitted between the upper case 22 and the lower case 24 as a result of the upper end portions thereof being brought into engagement with the upper case groove 22G and the lower end portions thereof being brought into engagement with the lower case rib 24R.

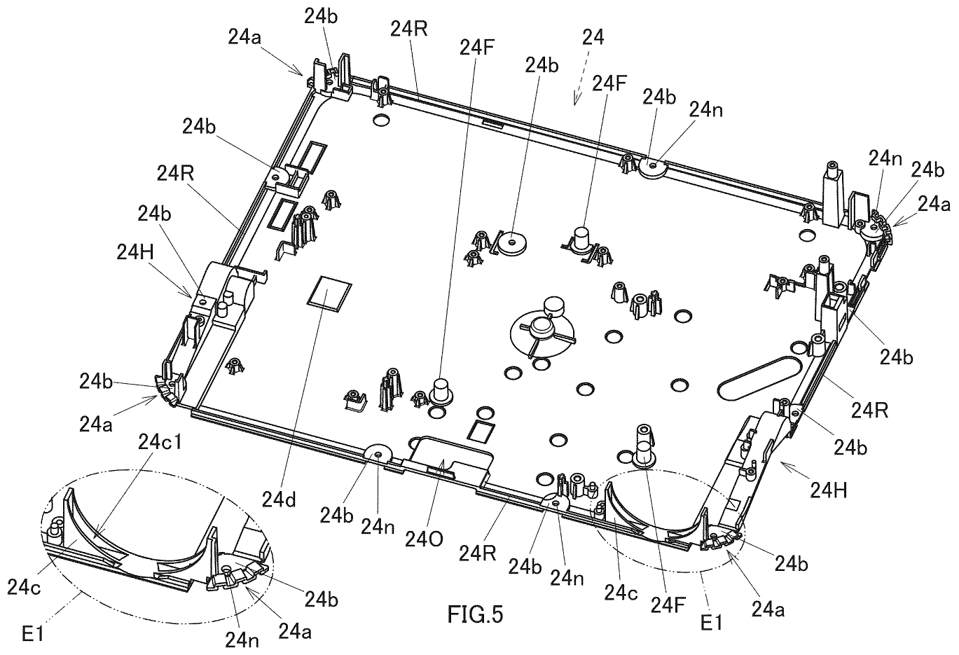

Subsequently, referring to FIGS. 3 and 5, the lower case 24 will be described.

The lower case 24 is made up of a substantially rectangular flat plate member having four rounded corners, and the internal parts IP of the projector 10 are mounted on an upper surface side of the lower case 24.

The material of the lower case 24 is, for example, a magnesium alloy produced by a die casting method, and the heat conductivity of the magnesium alloy is 51.2 (W/m·K).

Multiple threaded holes and bosses are provided on the upper surface side of the lower case 24 to mount the internal parts IP.

An engagement portion (an engagement area) 24a, which is provided into a concave/convex configuration in the up-down direction, is provided at an end portion of each of the four corners on the upper surface side of the lower case 24.

Each engagement portion 24a is made up of three concave portions which are opened downwards and two convex portions which protrude downwards (refer to an enlarged view E1 shown in FIG. 5).

In addition, threaded holes 24F are provided in multiple locations on the lower surface 24 to thread fasten a wire for suspending the projector 10 from a ceiling via threaded holes 26F, which will be described later.

Additionally, the upper case 22 and the lower case 24 may be formed into quadrangular shapes which can fit in and on each other.

On the upper surface side of the lower case 24, boss receivers 24b are provided in positions which coincide with the bosses B provided on the upper case 22 in the up-down direction to receive the distal end portions of the bosses B.

A threaded hole 24n is provided in each boss receiver 24b. Additionally, on the upper surface side of the lower case 24, a lower support (a support area) 24c, which is configured to support a lower side of the end portion of the lens barrel 42 where the projection port 11 is provided, is provided at a portion which coincides with the end portion of the lens barrel 42 where the projection port is provided 11.

The lower support 24c protrudes substantially into an arc shape which is defined long the outer circumferential surface of the lens barrel 42 with a concave surface of the arc shape directed upwards.

As shown in an enlarged view in FIG. 5, an internal portion of the lower support 24c is hollowed out to thereby be formed into a hollowed-out portion 24c1.

A lower case rib 24R is provided on external edge portions of the upper surface side of the lower case 24 along external edges thereof.

The lower case rib 24R is provided along substantially a full circumference of an internal surface side, that is, the upper surface side of the lower case 24 in such a manner as to rise perpendicularly into a rib from the external edge portions.

On the other hand, a case-side hinge attachment portion 24H is provided on each of left and right sides of a front portion of a lower surface side of the lower case 24 for attachment of the tilt hinge mechanism of the projector 10.

A positioning opening 240 is provided substantially at a center of the front portion of the lower case 24 in the left-right direction, and this positioning opening 240 is opened substantially into a rectangular shape and is configured to position the bottom cover 26 with respect to the lower case 24.

Here, on the upper surface side of the lower case 24, a convex portion (a protruding area) 24d, which is worked so as to protrude upwards (towards the IC 46a) into a convex shape, is provided in a position lying on a right side and slightly forwards and corresponding to a lower side of the IC 46a on the IC circuit board 46.

The convex portion 24d is formed substantially into a truncated quadrangular pyramid of a square shape as viewed from an upper side and is provided in such a manner that four sides thereof follow four sides of the lower case 24.

As shown in FIG. 9, a protruding height L1 of the convex portion 24d is smaller than a distance L2 from a plate surface of the lower case 24 to a plate surface of the IC circuit board 46.

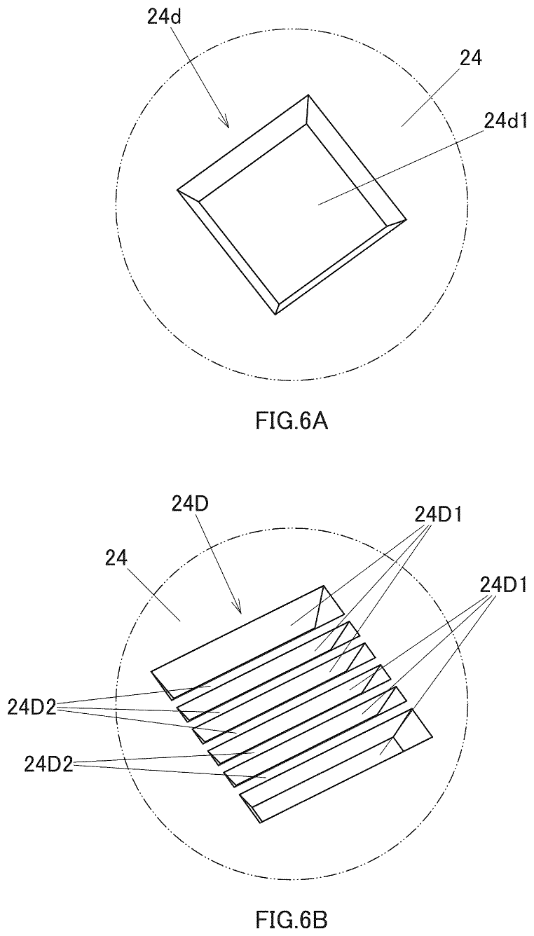

As shown in FIG. 6A, when seeing from the lower surface side of the lower case 24, the convex portion 24d is formed in such a manner as to protrude upwards by a concave portion 24d1 which is recessed from the lower surface side of the lower case 24.

As a modified example of the convex portion 24d, a protruding portion 24D may be provided as shown in FIG. 6B. That is, when seeing the lower case 24 from the lower surface side thereof, a group of concaves 24D1 is formed in which multiple portions are recessed by working from the lower surface side of the lower case 24, whereby the protruding portion 24D is provided which has heat radiation fins made up of multiple protrusions 24D2 which are each provided into a rib between any two adjacent concave portions 24D1 of the group of concaves 24D1.

Even in this case, when seeing the lower case 24 from the upper surface side thereof, the convex portion 24d keeps the shape shown in FIG. 5.

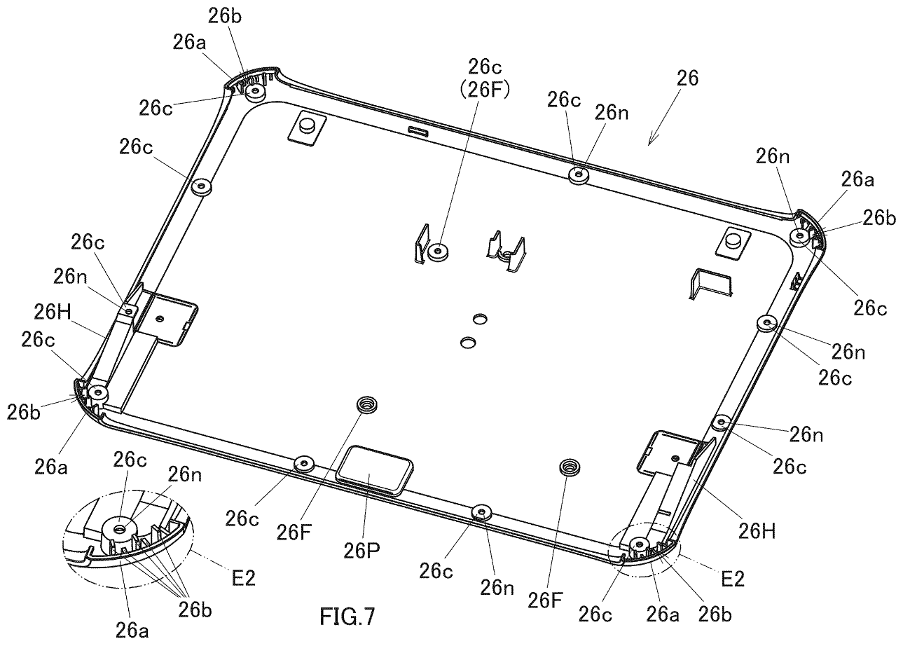

Subsequently, referring to FIGS. 3 and 7, the bottom cover 26 will be described.

The bottom cover 26 is a plate-shaped member having substantially a rectangular shape having four rounded corners and sized one size larger than the lower case 24.

As with the upper case 22, the material of the bottom cover 26 is, for example, a mixed resin of ABS and PC. Corner portion receivers 26a are provided in four corners on an upper surface side of the bottom cover 26 in such a manner as to be brought into abutment with the corresponding case corner portions 22a of the upper case 22.

The corner portion receivers 26a protrude slightly upwards from the four corners of the upper surface side of the bottom cover 26.

In addition, an external surface of each corner portion receiver 26a is formed into a rounded corner surface which follows an external surface of the corresponding case corner portion 22a.

Each corner portion receiver 26a is brought into abutment with the corner portion stopper 22a1 of the corresponding case corner portion 22a on an internal surface of a distal end portion thereof.

As a result, each case corner portion 22a of the upper case 22 is made to be locked on the corresponding corner receiver 26a of the bottom cover 26.

Additionally, the threaded holes 26F are provided in multiple locations on the bottom cover 26 to thread fasten the wire for suspending the projector 10 from the ceiling.

An engagement target portion (an engagement target area) 26b is provided on an internal surface side of each corner portion receiver 26a, and this engagement target portion 26b is worked so as to be brought into engagement with the corresponding engagement portion 24a of the lower case 24.

Each engagement target portion 26b is made up of multiple plate-shaped portions which protrude upwards and whose protruding heights differ so as to match the concave/convex configuration of the corresponding engagement portion 24a (refer to an enlarged view E2 in FIG. 7).

When viewed from the upper side of the projector 10, extending directions of the multiple plate-shaped portions of each engagement target portion 26b (directions intersecting surface directions of side surfaces of the plate-shaped portions at right angles) are directed substantially towards a center of the bottom cover 26.

As a result, in the engagement target portions 26b of the bottom cover 26 which are disposed in the four corners thereof, the extending directions of the multiple plate-shaped portions defer between any two engagement target portions 26b which lie adjacent to each other.

A holder 26c, which is configured to hold the corresponding boss receiver 24b of the lower case 24 between the corresponding boss B and itself, is provided in each of positions on the bottom cover 26 which coincide with the bosses B provided on the upper case 22 in the up-down direction.

Each holder 26c is provided substantially into a circular disk shape on the upper surface side of the bottom cover 26. A threaded hole 26n is provided in each holder 26c.

Here, a substantially rectangular positioning protruding portion 26P is provided substantially at a center of a front portion of the bottom cover 26 in such a manner as to protrude upwards so as to fit in the positioning opening 240 in the lower case 24.

Subsequently, an engagement form of the engagement portion of the lower case 24 with the engagement target portion of the bottom cover 26, a disposition form of the lens barrel 42 on the lower case 24, and an abutment form of the convex portion 24d with the IC circuit board 46 will be described by reference to FIGS. 8 and 9.

Here, as will be described later, in an assembling process of the projector 10, the bottom cover 26 is assembled last after the lower case 24, the internal parts IP, the panels 32, 34, 36, 38, and the upper case 22 are all assembled together. However, for the sake of description, only the lower case 24, the bottom cover 26, the lens barrel 42, and the IC circuit board 46 are shown in FIGS. 8 and 9.

As shown in FIG. 8, the bottom cover 26 is brought into abutment with substantially a whole surface of a lower surface of the lower case 24 on an upper surface thereof and is positioned as a result of the positioning protruding portion 26P fitting in the positioning opening 240 in the lower case 24, whereby the bottom cover 26 is assembled to the lower case 24 in such a manner as to cover the lower surface side of the lower case 24.

At this time, the engagement target portions 26b which are provided in the four corners of the bottom cover 26 are brought into engagement with the corresponding engagement portions 24a provided in the four corners of the lower case 24 (refer to an enlarged view shown in FIG. 8).

Specifically, protruding distal end portions of the multiple plate-shaped portions of each engagement target portion 26b are brought into abutment with the concave/convex lower side portions of the corresponding engagement portion 24a, whereby each engagement target portion 26b and the corresponding engagement portion 24a are fitted in and on each other without any gap defined in the up-down direction.

As a result, the four corners of the bottom cover 26 are fixed to the four corners of the lower case 24 strongly and rigidly. The cover-side hinge attachment portions 26H are brought into abutment with lower sides of the case-side hinge attachment portions 24H.

The external edge portions of the bottom cover 26 excluding the cover-side hinge attachment portions 26H are put in such a state that the external edge portions cover the outer circumferential surface of the lower case 24 excluding the case-side hinge attachment portions 24H.

The lens barrel 42 is disposed on the lower case 24 in such a state that the projection port 11 directed to the front is supported around a lower half portion thereof by the lower support 24c.

Here, a frame portion 42b is provided around the projection port 11 of the lens barrel 42, and the lens barrel 42 is disposed in such a manner that substantially a lower half portion around the projection port 11 is brought into abutment with the lower support 24c along a whole length of the lower support 24c as a result of the frame portion 42b being fitted in the hollow-out portion 24c1.

Further, the upper case 22 is assembled thereafter, whereby the projection port 11 is supported around substantially an upper half portion thereof by the upper support 22d, whereby substantially the upper half portion around the projection port 11 is brought into abutment with the upper support 22d along a whole length of the upper support 22d. As a result, the projection port 11 of the lens barrel 42 is closed hermetically therearound, whereby dust is prevented from entering from the circumference of the projection port 11.

As shown in FIGS. 2 and 9, the projector 10 includes a substantially rectangular heat conductive sheet (a heat conductive member) 60 which is interposed between the convex portion 24d on the lower case 24 and the IC circuit board 46. The heat conductive sheet 60 is disposed in a position which coincides with the IC 46a on the IC circuit board 46 in the up-down direction.

The heat conductive sheet 60 has a thickness which is slightly larger than a distance between the convex portion 24d and the IC circuit board 46 (a distance resulting from subtracting the height L1 from the distance L2 as shown in FIG. 9) and is provided in such a state that the heat conductive sheet 60 is compressed in the up-down direction.

As a result, a substantially whole surface of an upper surface of the heat conductive sheet 60 is in abutment with the IC circuit board 46, while a substantially whole surface of a lower surface of the heat conductive sheet 60 is in abutment with the convex portion 24d, whereby heat generated in the IC 46a is designed to be conducted effectively from the IC circuit board 46 to the convex portion 24d.

Here, the IC circuit board 46 may be brought into direct abutment with the convex portion 24d without interposition of the heat conductive sheet 60 therebetween.

Subsequently, an assembling method of the case 20 which makes up the projector 10 and a form of conducting heat generated in the IC 46a in the projector 10 will be described.

In an assembling process of the case 20, in the case 20, firstly, the internal parts IP of the projector 10 which are accommodated inside the case 20 are mounted on the lower case 24 for assemblage.

Subsequently, the lower end portions of the panels 32, 34, 36, 38 are brought into engagement with the lower case rib 24R of the lower case 24.

That is, as shown in FIG. 4, the panels 32, 34, 36, 38 are brought into engagement with the external edges of the lower case 24 in such a state that the panels 32, 34, 36, 38 are erected around the internal parts IP.

Subsequently, the upper case 22 is positioned so that the bosses B on the upper case 22 coincide with the boss receivers 24b on the lower case 24 in the up-down direction.

Then, the upper case 22 so positioned is placed on the panels 32, 34, 36, 38, and the upper case 22 is made to coincide with the panels 32, 34, 36, 38 in the up-down direction.

In other words, the upper case 22 is disposed above the internal parts IP mounted on the lower case 24. At this time, the upper case 22 is placed in such a manner as to cover the internal parts IP from an upper side while bringing the upper case groove 22G into engagement with the upper end portions of the panels 32, 34, 36, 38.

As a result, the panels 32, 34, 36, 38 are held between the upper case 22 and the lower case 24 in such a state that the panels 32, 34, 36, 38 are kept in engagement with the upper case 22 and the lower case 24 strongly and rigidly, and the distal end portions of the bosses B are brought into abutment with or are moved closely to the corresponding boss receivers 24b.

Subsequently, the whole of the case 20 is turned over so that the lower surface of the lower case 24 is directed or faces upwards, and the bottom cover 26 is positioned in such a manner that the four corners of the bottom cover 26 coincide with the four corners of the lower case 24 and that the positioning protruding portion 26P of the bottom cover 26 coincides with the positioning opening 240.

Then, the positioning protruding portion 26P is fitted in the positioning opening 240 while bringing the engagement target portions 26b into engagement with the corresponding engagement portions 24a, and the bottom cover 26 is placed over the lower case 24.

As a result, the upper surface of the bottom cover 26 is brought into abutment with a substantially whole surface of the lower surface of the lower case 24, and the holders 26c are brought into abutment with or are moved closely to lower surfaces of the corresponding boss receivers 24b, whereby the bottom cover 26 is attached to the lower case 24 in such a manner as to cover the lower surface and the outer circumferential surface of the lower case 24.

Here, the concave portion 24d1 on the lower surface side of the convex portion 24d is kept invisible from an exterior of the case 20 as a result of the bottom cover 26 covering the lower surface of the lower case 24.

As a result of the bottom cover 26 being assembled to the lower case 24, the corner portion receivers 26a of the bottom cover 26 are brought into abutment with the corresponding case corner portions 22a of the upper case 22, whereby the corner portion stoppers 22a1 are locked on the corresponding corner portion receivers 26a.

Subsequently, screws are passed through the threaded holes 26n of the holders 26c, the threaded holes 24n of the boss receivers 24b, and the threaded holes Bn of the bosses B from the lower surface side of the bottom cover 26 for threading engagement therewith, whereby both the bottom cover 26 and the lower case 24 are fastened together to the bosses B.

As a result of both the bottom cover 26 and the lower case 24 being fastened together in the way described above, both the bottom cover 26 and the lower case 24 are attached together more hermetically. The constituent members making up the case 20 are assembled together strongly and rigidly through the process described heretofore.

With the projector 10 produced in the way described heretofore, heat generated in the IC 46a on the IC circuit board 46 is conducted effectively to the lower case 24 having the higher heat conductivity via the heat conductive sheet 60 from the IC circuit board 46 by way of the convex portion 24d.

The heat conducted to the lower case 24 is radiated from a substantially whole area of the lower case 24. In this way, with the projector 10, a cooling device like the lower case 24 is provided in addition to the cooling devices 51, 52, 53, and the cooling fan 56.

Consequently, even in the case that the amount of heat generated by the IC 46a or the like in the internal parts IP is high, heat generated from the internal parts IP is designed to be cooled effectively.

In addition, although the temperature of the lower case 24 is increased as a result of the heat generated from the internal parts IP being conducted to the lower case 24, since the lower surface side of the lower case 24 is covered with the bottom cover 26 whose heat conductivity is lower than that of the lower case 24, heat from an exterior of the case 20 is cut off, whereby an increase in the temperature of an external surface of the case 20 is suppressed.

With the projector 10 of the embodiment, since the increase in temperature is suppressed as described above, the temperature of the external surface of the case 20 can be reduced in the order of 4° C. more when compared with, for example, a configuration in which the projector 10 does not include the bottom cover 26, whereby the lower case 24 is exposed to the exterior of the case 20.

As a result, in such a state that a user lifts up the projector 10 which is being heated by the internal parts IP or the like with his or her hands, the hands of the user come to contact mainly not the lower case 24 but the bottom cover 26, thereby making it possible to reduce a risk of the hands of the user getting burnt.

Below, a comparison is provided between the related art exemplified by the previously mentioned Japanese Unexamined Patent Application Publication No. 2018-17964 and the projector according to this embodiment.

With the electronic apparatus described in the related art, when a high heat generating member is included in the internal structure, in the case that the lower case is formed of a metal having a high heat conductivity, heat tends to be conducted easily from the high heat generating member to the lower case side, whereby the temperature on the external surface of the case is increased. On the other hand, in the case that the lower case is formed from a resin having a low heat conductivity, heat tends to be conducted hardly from the high heat generating member to the lower case side, whereby heat from the high heat generating member is not radiated to the exterior of the case, whereby the cooling capability of the electronic apparatus is reduced.

In contrast to the above-described related art, the projector 10 according to this embodiment includes the upper case 22, the lower case 24 which is provided in such a manner that the internal parts IP are disposed between the upper case 22 and the lower case 24, and the bottom cover 26 configured to cover the lower surface side of the lower case 24, and the heat conductivity of the lower case 24 is higher than those of the upper case 22 and the bottom cover 26.

As a result, heat generated from the internal parts IP is conducted to the lower case 24 effectively so as to be radiated from the substantially whole area of the lower case 24, thereby making it possible to suppress the reduction in the cooling capability.

Further, since the lower surface side of the lower case 24 is covered with the bottom cover 26 whose heat conductivity is lower than that of the lower case 24, the increase in temperature on the external surface of the case 20 can be suppressed. In this way, with the projector 10, the reduction in the cooling capability can be suppressed while suppressing the increase in temperature on the external surface.

In addition, with the projector 10, the lower case 24 and the bottom cover 26 are both substantially rectangular, and the lower case 24 has the engagement portions 24a whose shape is worked in the four corners, while the bottom cover 26 has the engagement target portions 26b which are worked so as to be brought into engagement with the corresponding engagement portions 24a in the four corners.

The engagement portions 24a and the engagement target portions 26a are brought into abutment with each other at the multiple locations, whereby the four corners of the lower case 24 and the four corners of the bottom cover 26 are brought into strong and rigid engagement with each other. As a result, the heat insulation effect of the bottom cover 26 which is provided in such a manner as to cover the lower case 24 can be enhanced, whereby the increase in temperature on the external surface of the cover 20 can be suppressed further.

In addition, when seeing the projector 10 from above, the extending directions of the multiple plate-shaped portions of each or one engagement target portion 26b differ from the extending directions of the multiple plate-shaped portions of the engagement target portions 26b which lie adjacent thereto. As a result, even in the case that an external force is applied to the bottom cover 26 along the extending direction of the multiple plate-shaped portions of any one of the engagement target portions 26b, the acting direction of the external force constitutes a direction which intersects the extending directions of the multiple plate-shaped portions of the adjacent engagement target portions 26b, whereby a structure is provided in which the bottom cover 26 is hardly detached from the lower case 24.

With the projector 10, the internal parts IP include the IC 46a (the IC circuit board 46) which constitutes a high heat generating member, and the lower case 24 has the convex portion 24d which is worked into the protruding shape which protrudes towards the IC 46a.

As a result, since the IC circuit board 46 is brought into direct contact with the convex portion 24d or is brought into indirect contact with the convex portion 24d via the heat conductive sheet 60, heat generated in the IC 46a is conducted effectively to the lower case 24 via the convex portion 24d, whereby the heat radiation effect of the lower case 24 can be enhanced, thereby making it possible to suppress the reduction in the cooling capability of the projector 10 further.

The projector 10 includes the heat conductive sheet 60 which is interposed between the IC 46a and the convex portion 24d. As a result, heat generated in the IC 46a is conducted effectively to the convex portion 24d via the heat conductive sheet 60. Due to this, the heat radiation effect of the lower case 24 can be enhanced, whereby the reduction in the cooling capability of the projector 10 can be suppressed further.

With the projector 10, in the case that, as the modified example of the convex portion 24d, the protrusions 24D2 are provided which are made up of multiple protrusions which are each formed into the rib, as shown in FIG. 6B, the strength and durability of the protrusions 24D2 can be enhanced. In addition, compared with the convex portion 24d, with the protruding portion 24D, a surface area thereof is increased by such an extent corresponding to side walls of the protrusions 24D2, whereby heat can easily be radiated, thereby making it possible to enhance the reliability of the projector 10 in which the heat radiation effect of the lower case 24 is enhanced.

In addition, with the projector 10, the material of the lower case 24 is magnesium alloy which is produced by the die casting method. As a result, the strength, lightness, workability, and the like of the lower case 24 can be enhanced.

As a result, not only can the reliability of the projector 10 be enhanced, but also a reduction in the weight of the projector 10 can be realized. Further, the convex portion 24d can easily be formed on the lower case 24.

With the projector 10, the bottom cover 26 is provided in such a manner as to be brought into abutment with the substantially whole surface of the lower surface side of the lower case 24.

As a result, heat radiated from the lower case 24 can be insulated effectively by the substantially whole surface of the bottom cover 26, whereby the heat insulation effect of the bottom cover 26 can be enhanced, thereby making it possible to suppress the increase in temperature on the external surface of the case 20.

Further, in the case that the bottom cover 26 is formed from resin as in the case with the present embodiment, there is a fear that so-called solvent cracking is generated in the bottom cover 26.

However, even in the case that the projector 10 is disposed to be suspended from a ceiling or the like, since the lower case 24 formed of the metallic material such as magnesium alloy or the like is thread fastened by the wire suspended from the ceiling, even though solvent cracking is generated in the bottom cover 26, the projector 10 can be prevented or restrained from falling.

In addition, in this case, since the bottom cover 26 is positioned on a ceiling side, and the upper case 22 is positioned on a floor side, the bottom cover 26 hardly comes off to fall on the floor. As a result, the safety of the projector 10 can be enhanced.

Further, in the case that an external case is constructed to be divided into an upper case and a lower case and that the upper and lower cases are formed of or from different materials, there may be a case in which even though the upper and lower cases are painted with the same material, the upper and lower cases exhibit different tints. However, with the present embodiment, even though the lower case 24 is made of metal, the lower case 24 is covered with the bottom cover 26 which is made from the same resin as the resin from which the upper case 22 is made. Thus, as the external case, the upper case and the lower case are formed from the same material, whereby the tints of the external surfaces of the cases can be unified easily, thereby making it possible to enhance the design property of the projector 10.

The projector 10 described heretofore as the electronic apparatus constitutes the projector 10 which includes the lens barrel 42 in the internal parts IP and in which projected light is emitted from the projection port 11 of the lens barrel 42, and the lower case 24 has the lower support 24c which is provided so as to support the end portion of the lens barrel 42 where the projection port 11 is provided. As a result, since the projection port 11 of the lens barrel 42 is supported by the lower support 24c, the lower side portion around the projection port 11 of the lens barrel 42 is sealed.

As a result, in the assembling process of the projector 10, the lens barrel 42 only need be disposed in a straight line from above the lower case 24 in such a manner that the circumference of the projection port 11 is supported by the lower support 24c with the projection port 11 directed towards the light emission side. Hence, since the lens barrel 42 does not have to be disposed temporarily, that is, the lens barrel 42 does not have to be disposed in an inclined fashion in advance, the assembling process of the projector 10 can be made simple and easy.

The embodiment described heretofore is presented as the example, and hence, there is no intention to limit the scope of the present invention by the embodiment. The novel embodiment can be carried out in other various forms, and various omissions, replacements and modifications can be made thereto without departing from the spirit and scope of the present invention.

Those resulting embodiments and modified examples thereof are included in the scope and gist of the present invention and are also included in the scope of inventions claimed for patent under claims below and their equivalents.

For example, in the embodiment described heretofore, although the projection port opening portion where the projection port of the lens barrel is exposed is described as being provided in the front panel, a configuration may be adopted in which a part of the bottom cover is erected around the projection port of the lens barrel, and an opening portion where the projection port of the lens barrel is exposed is provided in the bottom cover.

In this case, a conversion lens may be configured to be attached to the opening portion where the projection port is exposed.

In addition, in the embodiment described heretofore, although the upper surface side of the upper case is described as being exposed from the external surface of the case, a configuration may be adopted in which the upper surface side of the upper case is covered by the bottom cover by increasing the size of the bottom cover. In this case, the strength and hermetic closeness of the projector can be enhanced, and further, the projector having a superior dust-proof effect can be realized.

What is claimed is:

1. An electronic apparatus comprising:
a first case;
a second case provided in such a manner that an internal part is disposed between the first case and the second case; and
a cover configured to cover an opposite side of the second case to a side facing the internal part,
wherein a heat conductivity of the second case is higher than a heat conductivity of the cover.

2. The electronic apparatus according to claim 1,
wherein the second case and the cover are rectangular,
wherein the second case has an engagement area provided in at least one of four corners, and
wherein the cover has an engagement target area provided in at least one of four corners in such a manner as to be brought into engagement with the engagement area.

3. The electronic apparatus according to claim 1,
wherein the internal part comprises a heat generating member, and
wherein the second case comprises a protruding area provided in such a manner as to protrude towards the heat generating member.

4. The electronic apparatus according to claim 3, comprising:
a heat conductive member interposed between the heat generating member and the protruding area.

5. The electronic apparatus according to claim 3,
wherein the protruding area comprises multiple protruding portions, each of which is arranged in a rib-like manner.

6. The electronic apparatus according to claim 1,
wherein a material of the second case is a magnesium alloy.

7. The electronic apparatus according to claim 1,
wherein the second case comprises a lens barrel support area which is configured to support a lower side of the end portion of the lens barrel

8. The electronic apparatus according to claim 1,
wherein a material of the cover is a mixed resin.

9. The electronic apparatus according to claim 3,
wherein the heat generating member is disposed at a position separated from a lens barrel on the second case.

10. The electronic apparatus according to claim 1,
wherein the cover is provided in such a manner as to be brought into abutment with a substantially whole surface of the opposite side of the second case.

11. The electronic apparatus according to claim 1,
wherein the internal part comprises a lens barrel,
wherein the electronic apparatus is a projector in which projected light is emitted from a projection port of the lens barrel, and
wherein the second case comprises a support area provided in such a manner as to support the projection port of the lens barrel.
